(19) United States
(12) Patent Application Publication
(10) Pub. No.: US 2016/0059913 A1
(43) Pub. Date: Mar. 3, 2016

(54) Collapsible Towing Dolly

(71) Applicants: Steven Berger, St. Paul, MN (US); David Lysaker, Pelican Rapids, MN (US)

(72) Inventors: Steven Berger, St. Paul, MN (US); David Lysaker, Pelican Rapids, MN (US)

(21) Appl. No.: 14/837,755

(22) Filed: Aug. 27, 2015

Related U.S. Application Data
(60) Provisional application No. 62/042,409, filed on Aug. 27, 2014.

(51) Int. Cl. B62D 53/04

(52) U.S. Cl. CPC B62D 53/04

(57) ABSTRACT

A collapsible towing dolly with a rectangular frame for assembly on a driving surface beneath a towed vehicle. Four sides of the rectangular frame cradle a pair of opposing tires on the towed vehicle. The rectangular frame can be adjusted in size to accommodate different towed vehicles. The corners of the rectangular frame flex, so that the frame displaces in parallelogram fashion when pulled around a curve, allowing the towed vehicle to track behind the tow vehicle. The rectangular frame is raised off the driving surface by means of a liftable attachment between the rectangular frame and each of a pair of dolly wheel assemblies. Alternatively, jacks attached to the rectangular frame lift the rectangular frame. The rectangular frame attaches to a standard hitch on the tow vehicle via a tongue assembly removably attached to the rectangular frame.

### CROSS REFERENCE TO RELATED APPLICATIONS:

This application claims priority to U.S. Provisional Patent Application No. 62/042,409 filed 27 Aug. 2014 to the above named inventor, and is herein incorporated by reference in its entirety.

### FEDERALLY SPONSORED RESEARCH OR DEVELOPMENT

Not Applicable

### SEQUENCE LISTING, A TABLE, OR A COMPUTER PROGRAM

Not Applicable

### BACKGROUND OF THE INVENTION

Towing dollies that function by raising an opposing pair of tires on a vehicle requiring towing have long been known in the art. Existing towing dollies are generally bulky, heavy, and require significant exertion to operate. Also, many existing towing dollies can only be used in conjunction with a tow vehicle specifically designed and outfitted for towing vehicles.

### SUMMARY OF THE INVENTION

A towing dolly embodying the principles of the invention can be broken apart and easily stored in a tow vehicle when not in use. The only special requirement of the tow vehicle is that it has a standard hitch to allow attachment of a tongue on the towing dolly. An operator assembles four sides of a rectangular-shaped frame of the towing dolly on a driving surface beneath the tow vehicle, so that the four sides cradle a pair of opposing tires to be raised on a towed vehicle. In a preferred embodiment, the rectangular frame can be adjusted in size to accommodate different towed vehicles. The four corners of the rectangular frame are designed to rotatably flex in a horizontal plane, so that the entire frame flexes in parallelogram fashion when the towing dolly is pulled around a curve or turn, allowing the towed vehicle to track appropriately and safely behind the tow vehicle.

The rectangular frame cradling the opposing pair of tires on the towed vehicle is raised off of the driving surface by means of a liftable attachment between left and right side cross members of the rectangular frame and each of a pair of dolly wheel assemblies. A variety of means for lifting the rectangular frame are possible including hydraulic, screw-driven, pulley-driven, lever-and-ratchet driven, pneumatic, or any other manner of achieving sufficient mechanical advantage to raise the rectangular frame of the towing dolly and one end of the towed vehicle above a driving surface to a height sufficient to allow dolly-style towing.

These and other features of the present invention will be more readily and fully understood by reference to the accompanying illustrations and the detailed description that follows.

### BRIEF DESCRIPTION OF THE SEVERAL VIEWS OF THE ILLUSTRATIONS

The accompanying illustrations are included to provide a further understanding of the present invention and are incorporated in and constitute a part of this specification. The illustrations depict exemplary embodiments of the present invention and together with the description serve to further explain the principles of the invention. Other aspects of the invention and the advantages of the invention will be better appreciated as they become better understood by reference to the Detailed Description when considered in conjunction with accompanying illustrations, and wherein:

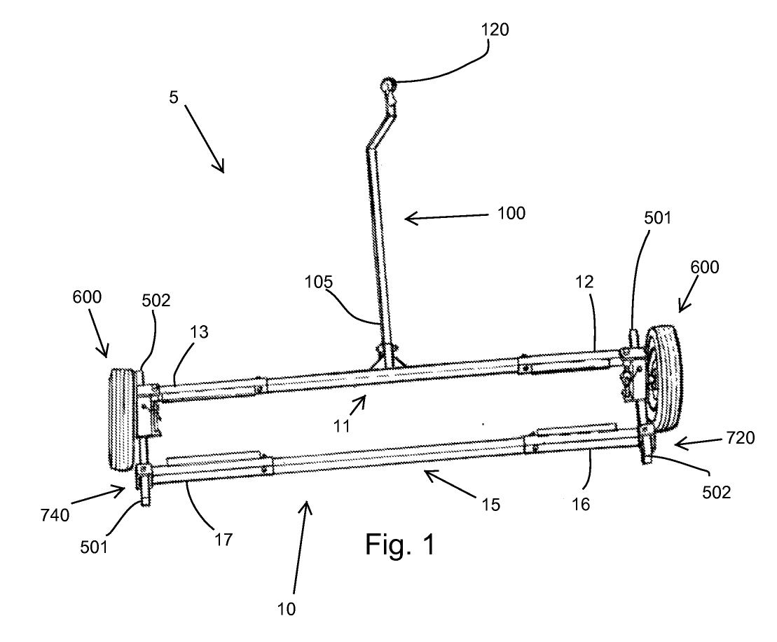

FIG. 1 is perspective view of one embodiment of the collapsible towing dolly according to the present invention;

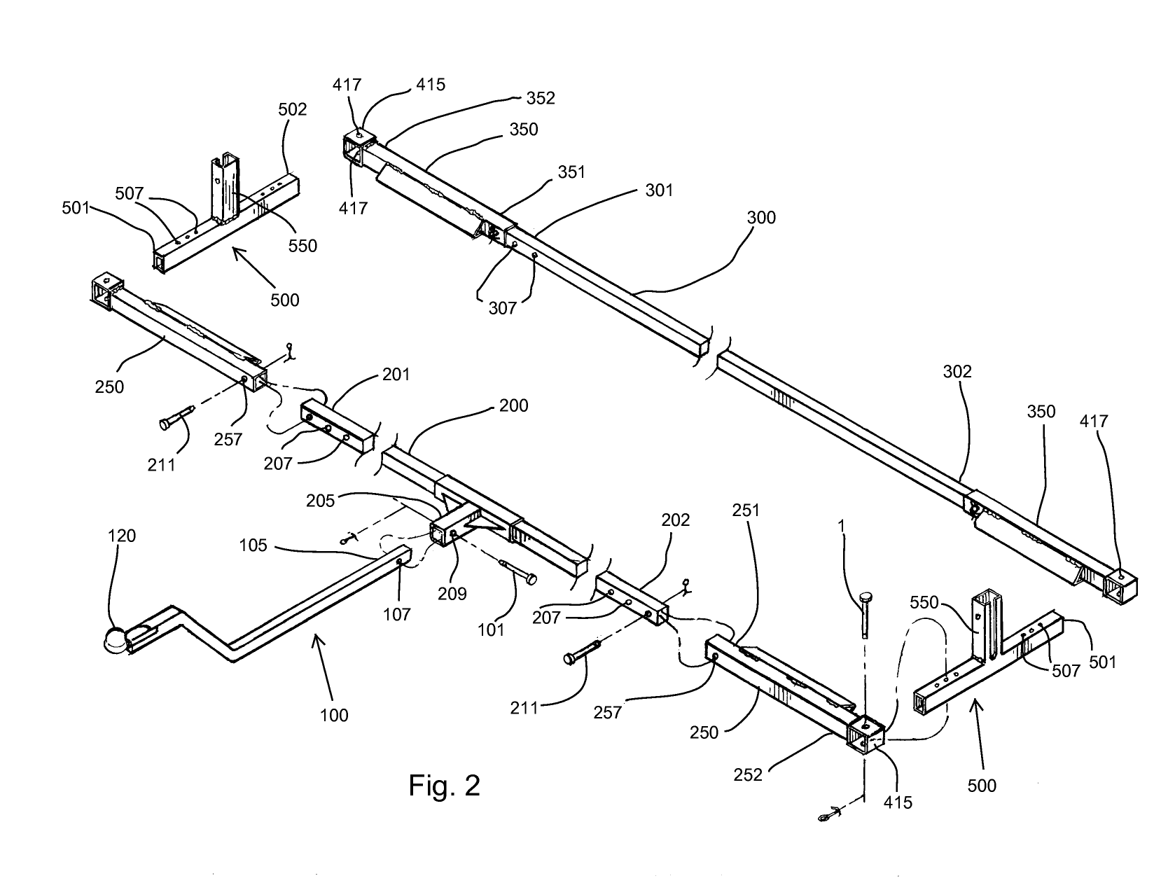

FIG. 2 is an exploded view of one embodiment of the rectangular frame and tongue assembly of the towing dolly according to the present invention;

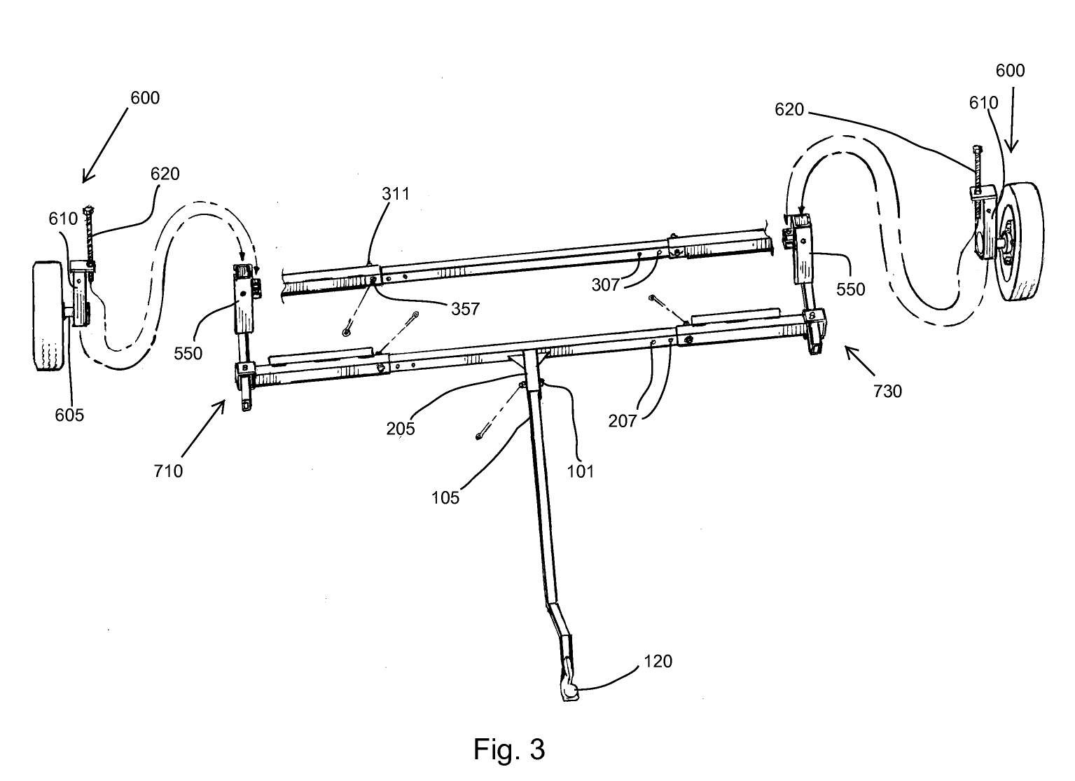

FIG. 3 is a perspective view showing one embodiment of the attachment of the dolly wheel assemblies to the side cross members according to the present invention;

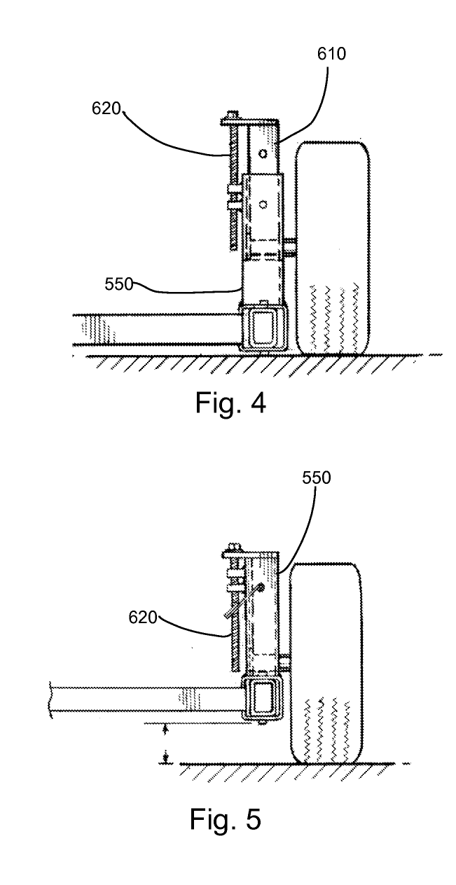

FIG. 4 is a partial side view showing the rectangular frame of the dolly in a lowered position according to one embodiment of the present invention;

FIG. 5 is a partial side view showing the rectangular frame of the dolly in a raised position according to one embodiment of the present invention;

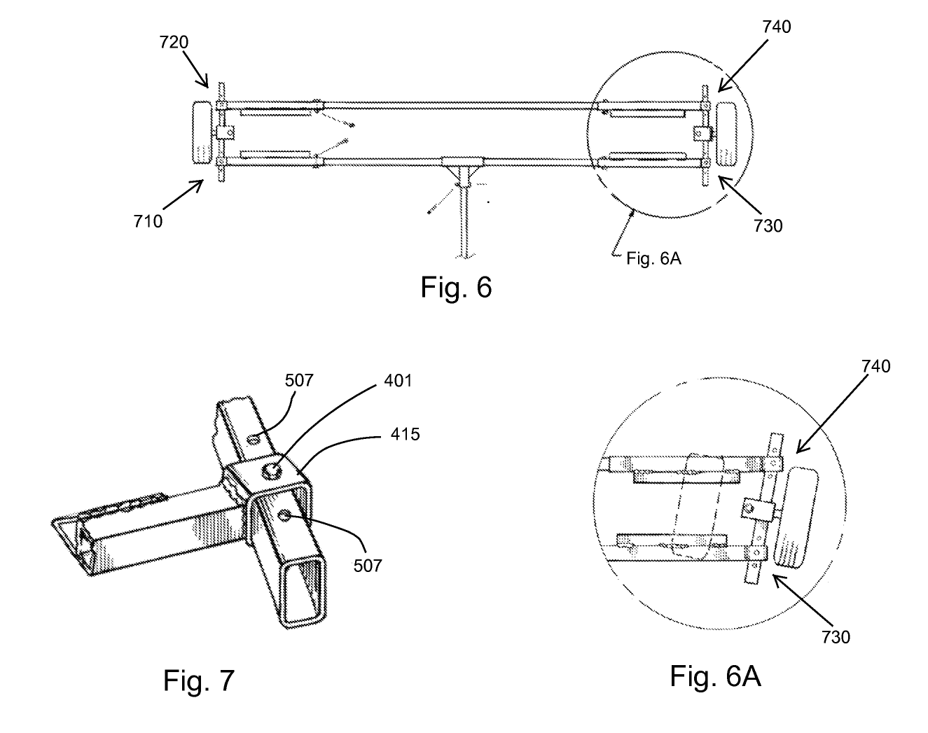

FIG. 6 is a view from directly above of the dolly as positioned when traveling straight forward according to one embodiment of the present invention;

FIG. 6A is an enlarged view from above of the left side of the dolly (as indicated in FIG. 6) as positioned when the dolly is being towed around a curve to the right according to one embodiment of the present invention;

FIG. 7 is a close-up perspective view of a flexing joint of the dolly according to one embodiment of the present invention;

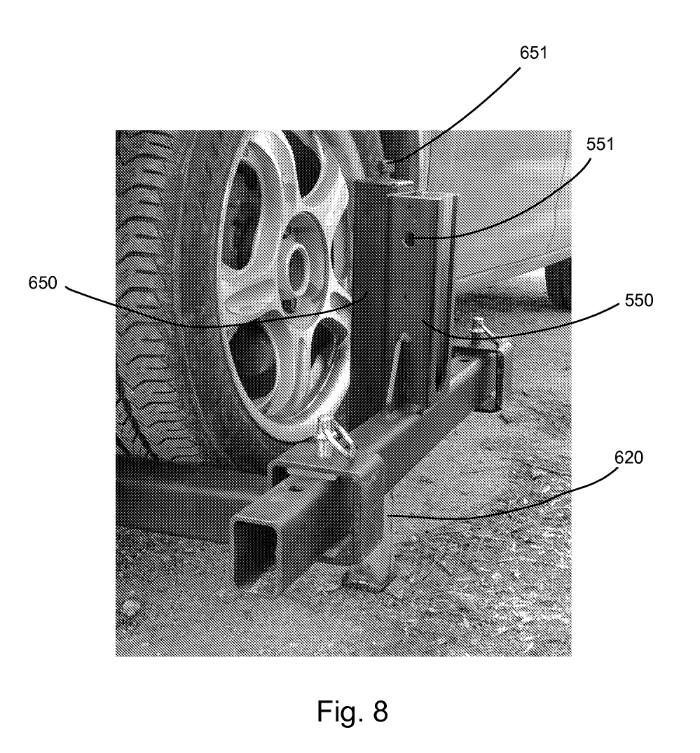

FIG. 8 is an isometric view of an alternative embodiment of the invention employing a jack to raise the dolly into towing position;

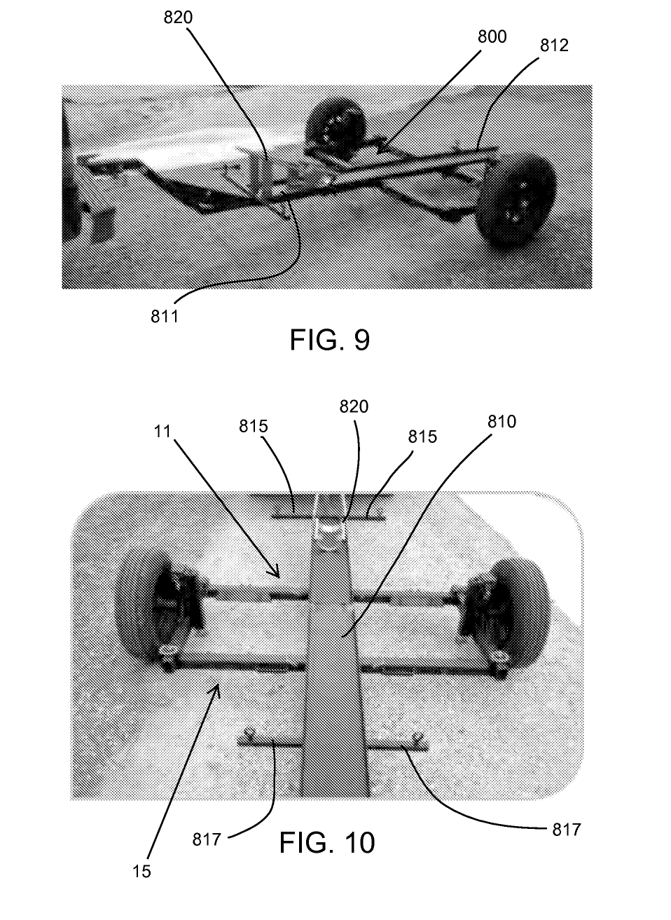

FIG. 9 is an isometric of an embodiment of the invention with an optional motorcycle towing attachment in place; and

FIG. 10 is an alternative isometric view of an embodiment of the invention with an optional motorcycle towing attachment in place.

### DETAILED DESCRIPTION OF THE INVENTION

Referring now to FIG. 1-3, a collapsible towing dolly, generally referred to as dolly 5, is shown for attachment between a tow vehicle (not shown) and a towed vehicle (not shown). The collapsible towing dolly 5 is comprised of a rectangular frame 10. For the purposes of this document, the terms “left,” “right,” “front,” and “rear” are to be interpreted from the perspective of an operator seated in a driver's position in the tow vehicle. The rectangular frame 10 is bounded by four sides; the four sides comprising a front cross member 11, a rear cross member 15, and a pair of side cross members 500; the four sides joined by four flexing joints (710, 720, 730, and 740). The rectangular frame 10 is sized to cradle an opposing pair of tires to be raised on the towed vehicle.

The four flexing joints including a right-front flexing joint 710, a right-rear flexing joint 720, a left-front flexing joint 730, and a left-rear flexing joint 740. The right front flexing joint 710 being a means for hinged attachment of a right end of the front cross member 12 and a first end of one of the pair of side cross members 501, allowing limited rotation of the right front flexing joint 710 in a horizontal plane. The right-rear flexing joint 720 being a means for hinged attachment of the right end of the rear cross member 16 and the second end of one of the pair of side cross members 502, allowing limited rotation of the right rear flexing joint 720 in a horizontal plane. The left front flexing joint 730 being a means for hinged attachment of the left end of the front cross member 13 and the second end of one of the pair of side cross members 502, allowing limited rotation of the left front flexing joint 730 in a horizontal plane. The left rear flexing joint 740 being a means for hinged attachment of the left end of the rear cross member 17 and the first end of one of the pair of side cross members 501, allowing limited rotation of the left rear flexing joint 740 in a horizontal plane. As shown in FIGS. 6 and 6A, the limited horizontal rotation of the four flexing joints (710, 720, 730, and 740) allows the rectangular frame 10 to flex in parallelogram fashion when the towing dolly 5 is pulled around a curve or turn by the tow vehicle, so that the towed vehicle tracks appropriately and safely behind the tow vehicle.

FIG. 7 provides a detailed view of a preferred embodiment of one of the four flexing joints (710, 720, 730, and 740). In this embodiment, a turning bracket 415, having a hollow aperture, is affixed to one of the ends of the front cross member (12 or 13) or one of the ends of the rear cross member (16 or 17). The turning bracket further includes a pair of bracket pin holes 417. The hollow aperture of the turning bracket is sized and positioned to loosely receive the first end 501 or the second end 502 of one of the pair of side cross members 500. At least one side cross member connecting pin hole 507 is positioned near the first end 501 and the second end 502 of each of the pair of side cross members 500. A turning bracket pin 401 is removably inserted through the pair of turning bracket holes 417 and one of the side cross member connecting pin holes 507, rotatably affixing one end of the pair of side cross members 500 to one end of the front cross member 11 or the rear cross member 15. A plurality of side cross member connecting pin holes 507 allows the rectangular frame 10 to be sized to cradle tires with contact patches of varying length on the towed vehicle.

In a preferred embodiment of the present invention, the front cross member 11 has as adjustable length and the rear cross member 15 has an adjustable length, which allows the dolly 5 to accommodate towed vehicles with different outside widths between the opposing pair of tires to be raised. In the embodiment shown most clearly in FIG. 2, the front cross member 11 comprises a front central cross member 200 and a pair of front outer cross members 250. The front central cross member 200 having a right end 201 and a left end 202, each end having a plurality of front cross member sizing holes 207. Each of the pair of front outer cross members 250 includes a first end 251 and a second end 252. The second end 252 is affixed to one of the four turning brackets 415 and the first end 251 has a hollow tubular structure sized to receive the right end 201 or the left end 202 of the front central cross member 200. The first end 251 further includes a pair of front cross member holes 257 aligned on opposite sides of the tubular structure. The pair of front cross member holes 257 are positioned to receive a front cross member pin 211 removably inserted through the pair of front cross member holes 257 and one of the plurality of front cross member sizing holes 207 when the right end 201 or the left end 202 of the front central cross member 200 is received within the first end 251 of one of the pair of front outer cross members 250, allowing the operator to adjust the length of the front cross member 11.

Similarly, in the embodiment shown most clearly in FIG. 2, the rear cross member 15 comprises a rear central cross member 300 and a pair of rear outer cross members 350. The rear central cross member 300 having a first end 301 and a second end 302, each end having a plurality of rear cross member sizing holes 307. Each of the pair of rear outer cross members 350 includes a first end 351 and a second end 352. The second end 352 is affixed to one of the turning brackets 415 and the first end 351 has a hollow tubular structure sized to receive the first end 301 or the second end 302 of the rear central cross member 300. The first end 301 further includes a pair of rear cross member holes aligned on opposite sides of the tubular structure. The pair of rear cross member holes 357 are positioned to receive a rear cross member pin 311 removably inserted through the pair of rear cross member holes 357 and one of the plurality of rear cross member sizing holes 307 when the first end 301 or the second end 302 of the rear central cross member 300 is received within the first end 351 of one of the pair of rear outer cross members 350, allowing the operator to adjust the length of the rear cross member 15.

As shown in FIGS. 1-3, the towing dolly also comprises a tongue assembly 100 centrally affixed to the front cross member 11. The tongue assembly 100 protrudes perpendicularly away from the front cross member toward physical communication with a hitch on the tow vehicle (not shown). The tongue assembly 100 has a front end including a ball socket 120 configured for removable attachment to the hitch.

Preferably, the front cross member 11 includes a means for removably affixing the tongue assembly 100 to the rectangular frame 10. In a preferred embodiment most clearly shown in FIG. 2, a tongue receiver 205 is centrally affixed between the right end 201 and the left end 202 of the front central cross member 200. The tongue receiver 205 protrudes perpendicularly from the length of the front cross member 11 in a direction for physical communication with a rear end 105 of the tongue assembly 100. The tongue receiver 205 has a tubular structure with a hollow interior, the hollow interior sized and shaped to receive the rear end 105 of the tongue assembly 100. The tongue assembly 100 includes a tongue hole 107 through the rear end 105. The tongue receiver 205 includes a pair of tongue receiver holes 209 aligned on opposite sides of the tubular structure. The tongue receiver holes 209 are positioned to receive a tongue pin 101 removably inserted through the aligned tongue hole 107 and the pair of tongue receiver holes 209 when the rear end 105 of the tongue assembly 100 is received within the tongue receiver 205, allowing an operator to removably affix the tongue assembly 100 to the front cross member 11.

The towing dolly 5 further comprises a pair of dolly wheel assemblies 600 each having a matching size and structure. Each dolly wheel assembly 600 includes a means for liftable attachment to one of the pair of side cross members 500 and a means for raising one of the pair of side cross members 500. After an operator has assembled the rectangular frame 10 around contact patches of the pair of opposing tires to be lifted on the towed vehicle, the operator engages the means for lifting the side cross members. After an operator has raised the opposing pair of tires on the towed vehicle, which are cradled in the rectangular frame 10 of the towing dolly 5, the operator can use the tow vehicle attached to the dolly via the tongue assembly 100 to transport the towed vehicle. One skilled in the art could devise a variety of mechanisms for liftable attachment between each of the dolly wheel assemblies 600 and each of the side cross members 500. Similarly, one skilled in the art could devise a variety of means for raising the side cross members 500, including hydraulic, screw-driven, pulley-driven, lever-and-ratchet driven, pneumatic, or any other manner of achieving sufficient mechanical advantage to raise the rectangular frame 10 of the towing dolly 5 and one end of the towed vehicle above a driving surface to a height sufficient to allow dolly-style towing.

In an embodiment shown in FIG. 3-5, the towing dolly 5 includes a pair of side cross-member pillars 550, each side cross-member pillar 550 having a matching size and structure. Each side cross-member pillar 550 is centrally affixed to one of the pair of side cross members 500, projecting perpendicularly upward from the side cross member 500. Each side cross-member pillar 550 has a hollow interior sized to receive an axle post 610 affixed to an axle 605 on one of the pair of dolly wheel assemblies 600. In the embodiment shown, one of a pair of vehicle-raising bolts 620 is used to liftably attach one of the pair of axle posts 610 to one of the pair of side cross-member pillars 550. The operator turns each vehicle-raising bolt 620 to draw each side cross-member pillar 550 upward, thus raising the rectangular frame 10 and one end of the towed vehicle to a height sufficient to allow dolly-style towing.

Each of the pair of side cross-member pillars 550 includes a first tow-position pin hole 551 and each of the pair of axle posts 610 includes a second tow-position pin hole 611. The first tow-position pin hole 551 and the second tow-position pin hole 611 are each sized to securely receive one of a pair of tow-position pins 601. The first tow-position pin hole 551 and the second tow-position pin hole 611 are brought into alignment when the operator raises the rectangular frame 10 to the height sufficient to allow dolly-style towing. The operator secures the rectangular frame 10 in a raised position by inserting each of the pair of tow position pins 601 through each of the pair of first tow-position pin holes 551 and second tow-position pin holes 611.

In an alternative embodiment shown in FIG. 8, each of a pair of jacks 650 is affixed to each of the pair of side cross-member pillars 550. The jack 650 having an extendable member 620 that protrudes downward when a jack bolt 651, or similar mechanism, is rotated by the operator. When the rectangular frame 10 is initially assembled around the opposing pair of tires to be raised on the towed vehicle, the extendable member 620 is withdrawn within the jack 650. The operator raises the rectangular frame 10 by rotating each of the pair of jack bolts 651 to cause each of the pair of extendable members 620 to protrude downward. When the rectangular frame 10 has reached a sufficient height, the operator inserts each of the pair of axle posts 610 (not shown in FIG. 8) into each of the pair of side cross-member pillars 550. The operator secures the rectangular frame 10 in a raised position by inserting each of the pair of tow-position pins 601 through each of the pair of first tow-position pin holes 551 and second tow-position pin holes 611. Before using the towing dolly 5 to tow a vehicle, the operator withdraws each of the pair of extendable members 620 within each of the pair of jacks 650 by rotating each of the pair of jack bolts 651 in an opposite direction as that required to extend the extendable members 620.

Referring now to FIGS. 9-10, one embodiment of an optional motorcycle towing attachment 800 is shown. The motorcycle towing attachment 800 is comprised of a motorcycle wheel channel 810, the motorcycle wheel channel 810 having sufficient length to support both a front wheel and a rear wheel of a motorcycle being towed. The motorcycle wheel channel is affixed to the front cross member 11 and the rear cross member 15. The motorcycle towing attachment also preferably includes a front-wheel cage 820 affixed near a front end 811 of the motorcycle wheel channel 810, the front-wheel cage 820 sized and structured to securely receive and provide lateral support for the front wheel of the motorcycle being towed. The motorcycle towing attachment 800 further includes a pair of front tie bars 815 and a pair of rear tie bars 817. One of the pair of front tie bars 815 protrudes perpendicularly away to the left from the front end 811 of the motorcycle wheel channel 810 and the other one of the pair of front tie bars 815 protrudes perpendicularly away to the right from the front end 811 of the motorcycle wheel channel 810. One of the pair of rear tie bars 817 protrudes perpendicularly away to the left from a rear end 812 of the motorcycle wheel channel 810 and the other one of the pair of rear tie bars 817 protrudes perpendicularly away to the right from the rear end 812 of the motorcycle wheel channel 810. The pair of front tie bars 815 and the pair of rear tie bars 817 provide locations for the operator to use chains, ropes, cables, or the like to secure the motorcycle being towed into position on the towing dolly 5.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) but that the invention will include all embodiments falling with the scope of this disclosure.

What is claimed is:

1. A towing dolly, the towing dolly attached between a tow vehicle and a towed vehicle, the towing dolly comprising:
A. a rectangular frame sized to cradle an opposing pair of tires to be raised on the towed vehicle, the rectangular frame bounded by four sides; the four sides comprising a front cross member, a rear cross member, and a pair of side cross members; the four sides being joined by four flexing joints;
i. the front cross member having a right end and a left end;
ii. the rear cross member having a right end and a left end;
iii. the front cross member and the rear cross member being equal in length;
iv. the pair of side cross members, each side member having a matching size and structure; each side cross member having a first end and a second end, a top side and a bottom side, the top side and the bottom side in communication to form a tubular structure;
v. the four flexing joints being a right-front flexing joint, a right-rear flexing joint, a left-front flexing joint, and a left-rear flexing joint;
a. the right front flexing joint being a means for hinged attachment of the right end of the front cross member and the first end of one of the pair of side cross members, allowing limited rotation of the flexing joint in a horizontal plane;
b. the right-rear flexing joint being a means for hinged attachment of the right end of the rear cross member and the second end of one of the pair of side cross members, allowing limited rotation of the flexing joint in a horizontal plane;
c. the left front flexing joint being a means for hinged attachment of the left end of the front cross member and the second end of one of the pair of side cross members, allowing limited rotation of the flexing joint in a horizontal plane;
d. the left rear flexing joint being a means for hinged attachment of the left end of the rear cross member and the first end of one of the pair of side cross members, allowing limited rotation of the flexing joint in a horizontal plane;
B. a tongue assembly having a rear-lower end, a front-upper end, and a riser section;
i. the rear-lower end affixed to a central point on the front cross member of the rectangular frame, the tongue assembly protruding perpendicularly away from the front cross member toward physical communication with a hitch on the tow vehicle;
ii. the front-upper end having a ball socket, the ball socket configured for removable attachment to the hitch;
iii. the riser section between the front-upper end and the rear-lower-end, wherein the riser section joins the front-upper end and the rear-lower end at a downward angle from the front-upper end to the rear-lower end, allowing the front-upper end to be at a height for removable attachment to the hitch and the rear-lower end to be at a height to pass below an underside of the towed vehicle;
C. a pair of dolly wheel assemblies, each dolly wheel assembly having a matching size and structure, each dolly wheel assembly comprising:
i. a dolly wheel;
ii. a dolly tire mounted to the dolly wheel;
iii. a dolly axle, the dolly axle including a first end and a second end;
the first end in rotational communication with the dolly wheel;
D. A pair of screw-powered means for lifting a side cross member of the rectangular frame, each screw-powered lifting means having a matching size and structure, each screw-powered lifting means having a first end and a second end;
i. the first end of each screw-powered lifting means attached to one of the pair of side cross members;
ii. the second end of each screw-powered lifting means attached to the second end of the axle on one of the pair of dolly wheel assemblies;
iii. whereby rotation of one of the pair of screw-powered lifting means raises a side of the rectangular frame cradling the opposing pair of tires to be raised on the towed vehicle;
iv. whereby rotation of the other one of the pair of screw-powered lifting means raises an opposite side of the rectangular frame cradling the opposing pair of tires to be raised on the towed vehicle; and
v. whereby the towed vehicle is able to be moved by the towing vehicle.

2. The towing dolly of claim 1, wherein the front cross member includes a means for removably affixing the tongue assembly to the rectangular frame.

3. The towing dolly of claim 1, wherein each of the pair of side cross members includes a means for adjusting the length of each of the pair of side cross members, whereby the rectangular frame can be adjustably sized to accommodate towed vehicles with different tire sizes.

4. The towing dolly of claim 1, wherein the front cross member includes a means for adjusting the length of the front cross member, and wherein the rear cross member includes a means for adjusting the length of the rear cross member, whereby the rectangular frame can be adjustably sized to accommodate towed vehicles with different outside widths between the opposing pair of tires to be raised.

5. The towing dolly of claim 1, wherein each of a pair of jacks is affixed to each of the pair of side cross-member pillars and wherein each of the jacks is movable to raise the rectangular frame.

6. The towing dolly of claim 1, wherein the dolly includes an attachment for a motorcycle, the attachment including a motorcycle wheel channel having a length to support a front wheel and rear wheel of a motorcycle, the attachment affixed to the front cross member and rear cross member.

7. A towing dolly, the towing dolly attached between a tow vehicle and a towed vehicle, the towing dolly comprising:
A. a rectangular frame sized and positioned to cradle an opposing pair of tires to be raised on the towed vehicle, the rectangular frame bounded by four sides; the four sides comprising a front cross member, a rear cross member, and a pair of side cross members; the four sides being joined by four flexing joints;
i. the front cross member having a right end, a left end, a top side and a bottom side, the top side and the bottom side in communication to form a tubular structure;
ii. the rear cross member having a right end and a left end, a top side and a bottom side, the top side and the bottom side in communication to form a tubular structure;
iii. the front cross member and the rear cross member having equal lengths;
iv. the pair of side cross members, each side member having a matching size and structure; each side cross member having a first end and a second end, a top side and a bottom side, the top side and the bottom side in communication to form a tubular structure;
v. the four sides of the rectangular frame being joined by four flexing joints, a right-front flexing joint, a right-rear flexing joint, a left-front flexing joint, and a left-rear flexing joint;
a. the right-front flexing joint including a flexing joint pin hole, the flexing joint pin hole in the first end of one of the pair of side cross members, the flexing joint pin hole projecting through the top side and the bottom side of the side cross member; the right-front flexing joint further including a turning bracket, the turning bracket affixed to the right end of the front cross member, the turning bracket having a top side and a bottom side in communication to form a hollow aperture, the hollow aperture sized and positioned to receive the first end of one of the pair of side cross members; the turning bracket further including a pair of bracket pin holes, each of the pair of bracket pin holes placed symmetrically opposite each other on the top side and the bottom side of the turning bracket; and a pin vertically inserted through the flexing joint pin hole and the pair of turning bracket holes positioned in alignment; whereby affixing the first end of one of the pair of side cross members to the right end of the front cross member;
b. the right-rear flexing joint including a flexing joint pin hole, the flexing joint pin hole in the second end of one of the pair of side cross members, the flexing joint pin hole projecting through the top side and the bottom side of the side cross member; the right-rear flexing joint further including a turning bracket, the turning bracket affixed to the right end of the rear cross member, the turning bracket having a top side and a bottom side in communication to form a hollow aperture, the hollow aperture sized and positioned to receive the second end of one of the pair of side cross members; the turning bracket further including a pair of bracket pin holes, each of the pair of bracket pin holes placed symmetrically opposite each other on the top side and the bottom side of the turning bracket; and a pin vertically inserted through the flexing joint pin hole and the pair of turning bracket holes positioned in alignment; whereby affixing the second end of one of the pair of side cross members to the right end of the rear cross member;
c. the left-front flexing joint including a flexing joint pin hole, the flexing joint pin hole in the second end of one of the pair of side cross members, the flexing joint pin hole projecting through the top side and the bottom side of the side cross member; the right-front flexing joint further including a turning bracket, the turning bracket affixed to the left end of the front cross member, the turning bracket having a top side and a bottom side in communication to form a hollow aperture, the hollow aperture sized and positioned to receive the second end of one of the pair of side cross members; the turning bracket further including a pair of bracket pin holes, each of the pair of bracket pin holes placed symmetrically opposite each other on the top side and the bottom side of the turning bracket; and a pin vertically inserted through the flexing joint pin hole and the pair of turning bracket holes positioned in alignment; whereby affixing the second end of one of the pair of side cross members to the left end of the front cross member;
d. the left-rear flexing joint including a flexing joint pin hole, the flexing joint pin hole in the first end of one of the pair of side cross members, the flexing joint pin hole projecting through the top side and the bottom side of the side cross member; the left-rear flexing joint further including a turning bracket, the turning bracket affixed to the left end of the rear cross member, the turning bracket having a top side and a bottom side in communication to form a hollow aperture, the hollow aperture sized and positioned to receive the first end of one of the pair of side cross members; the turning bracket further including a pair of bracket pin holes, each of the pair of bracket pin holes placed symmetrically opposite each other on the top side and the bottom side of the turning bracket; and a pin vertically inserted through the flexing joint pin hole and the pair of turning bracket holes positioned in alignment; whereby affixing the first end of one of the pair of side cross members to the left end of the rear cross member;
e. the four turning brackets, each turning bracket equally sized, the aperture of each turning bracket sized larger than the first end and the second end of each of the pair of side cross members to allow limited angular rotation in a horizontal plane of the first end and the second end of each of the side cross members within each turning bracket aperture, the limited angular rotation occurring about an axis formed by each of the four pins placed through each of four sets of the turning bracket pin holes and the flexing joint holes;
B. a tongue assembly comprising a rear-lower end, a front-upper end, and a riser section;
i. the rear-lower end affixed to a central point on the front cross member of the rectangular frame, the tongue assembly protruding perpendicularly away from the front cross member toward physical communication with a hitch on the tow vehicle;
ii. the front-upper end having a ball socket, the ball socket configured for removable attachment to the hitch;
iii. the riser section between the front-upper end and the rear-lower-end, wherein the riser section joins the front-upper end and the rear-lower end at a downward angle from the front upper end to the rear-lower end, allowing the front-upper end to be at a height for removable attachment to the hitch and the rear-lower end to be at a height to pass below an underside of the towed vehicle;
C. a pair of vehicle-raising towers, each vehicle-raising tower having a matching size and structure, each vehicle-raising tower comprising an upper end, a lower end, a first side, a second side, a proximal side, a distal side, a hollow interior, a pair of vehicle-raising tower pin holes, a female threaded receiver, and an axle channel;
i. the lower end affixed to a central point on the top side of one of the pair of side cross members, the vehicle-raising tower projecting perpendicularly away from one of the pair of side cross members to form an inverted “T” shape;
ii. the first side adjacent to the first end of one of the pair of side cross members;
iii. the second side opposite the first side and adjacent to the second end of one of the pair of side cross members;
iv. the proximal side facing the towed vehicle;
v. the distal side opposite the proximal side;
vi. the hollow interior formed by the longitudinal joining of the first side, the proximal side, the second side, and the distal side; the hollow interior sized to receive an axle tower on one of a pair dolly wheel assemblies;
vii. the pair of vehicle-raising tower pin holes, each of the pair of vehicle-raising tower pin holes placed symmetrically opposite each other on the first side and the second side of the vehicle-raising tower;
viii. the female threaded receiver affixed to the proximal side of the vehicle-raising tower, the female threaded receiver sized and positioned to screwably receive a threaded rod of a vehicle-raising bolt of one of the pair dolly wheel assemblies;
ix. the axle channel placed along a longitudinal center line of the distal side of the vehicle-raising tower, the axle channel having sufficient width to accommodate a diameter of a dolly axle on one of the pair dolly wheel assemblies;
D. the pair of dolly wheel assemblies, each dolly wheel assembly having a matching size and structure, each dolly wheel assembly comprising a dolly wheel, a dolly tire, a dolly axle, an axle tower, and a vehicle-raising bolt;
i. the dolly tire mounted to the dolly wheel;
ii. the dolly axle, the dolly axle including a first end and a second end; the first end in rotational communication with the dolly wheel;
iii. the axle tower, the axle tower sized to be received within the hollow interior of one of the pair of vehicle-raising towers; the axle tower comprising a lower end, an upper end, a first side, a second side, a proximal side, a distal side, a pair of axle tower pin holes, an axle tower top plate, a top plate bolt hole, and a vehicle-raising bolt;
a. the distal side of the axle tower facing the dolly wheel,
b. the second end of the dolly axle perpendicularly affixed to the lower end of the axle tower;
c. the proximal side of the axle tower opposite the distal side of the axle tower;
d. the proximal side of the axle tower and the distal side of the axle tower longitudinally joined by the first side of the axle tower and the second side of the axle tower; the first side of the axle tower opposite the second side of the axle tower;
e. the pair of axle tower pin holes, the axle tower pin holes placed symmetrically opposite each other on the first side and the second side of the axle tower;
f. the axle tower top plate, the axle tower top plate perpendicularly affixed to the top end of the axle tower; the axle tower top plate overhanging the top end of the axle tower on the proximal side of the axle tower;
g. the top plate bolt hole, the top plate bolt hole positioned on the overhanging portion of the axle tower top plate so that the top plate bolt hole is aligned with the female threaded receiver affixed to the proximal side of one of the pair of vehicle raising towers when the axle tower is received within the hollow interior of one of the pair of vehicle-raising towers; the top plate bolt hole having a diameter sized to slidably receive the threaded rod of the vehicle-raising bolt;
h. the vehicle-raising bolt comprising a head and the threaded rod; the head having a width greater than the diameter of the top plate bolt hole; and the threaded rod having sufficient length, diameter, and threading to engage with the female threaded receiver when the rectangular frame of the towing dolly is resting against a driving surface;
i. the threaded rod engaged with the female threaded receiver and the vehicle-raising bolt rotated by a suitable tool engaged with the head of the vehicle-raising bolt, the vehicle-raising tower is thereby drawn upwards toward the axle tower top plate;
j. whereby a side of the rectangular frame cradling the opposing pair of tires to be raised on the towed vehicle is lifted above the driving surface; whereby the axle tower pin holes and the vehicle-raising tower pin holes are brought into alignment allowing the side of the rectangular frame to be fixed in an upward position by a horizontally inserted pin;
k. whereby an opposite side of the rectangular frame cradling the opposing pair of tires to be raised on the towed vehicle is lifted above the driving surface and fixed into the upward position by the same mechanical interaction between an opposite one of the pair of axle towers and an opposite of one of the pair of dolly wheel assemblies; and
l. whereby the towed vehicle is able to be moved by the towing vehicle.

8. The towing dolly of claim 7, wherein a tongue receiver is centrally affixed between the right end and the left end of the front cross member;
A. the tongue receiver protruding perpendicularly from the length of the front cross member in a direction to be in physical communication with the rear-lower end of the tongue assembly;
B. the tongue receiver having a tubular structure with a hollow interior, the hollow interior sized and shaped to receive the rear-lower end of the tongue assembly;
C. the tongue assembly including a tongue hole through the rear-lower end of the tongue assembly;
D. the tongue receiver further comprising a pair of tongue receiver holes aligned on opposite sides of the tubular structure, the tongue receiver holes positioned to receive a pin removably inserted through the aligned tongue hole and the pair of tongue receiver holes when the rear-lower end of the tongue assembly is received within the tongue receiver;
E. whereby the tongue assembly is removably affixed to the front cross member.

9. The towing dolly of claim 7, wherein the first end and the second end of each of the pair of side cross members includes a plurality of equally spaced flexing joint pin holes projecting through the top side and the bottom side of each of the pair of side cross members, whereby a user can select an appropriate set of the flexing joint pin holes to size the rectangular frame to accommodate towed vehicles with different tires sizes.

10. The towing dolly of claim 7, wherein the front cross member comprises a front central cross member and a pair of front outer cross members; and wherein the rear cross member comprises a rear central cross member and a pair of rear outer cross members;
A. the front central cross member having a right end and a left end, the right end and the left each having a plurality of front cross member sizing holes;
B. each of the pair front outer cross members having a hollow tubular structure sized to receive the right end or the left end of the front central cross member, and each of the pair of front outer cross members having a first end and a second end;
i. the first end having a pair of front cross member holes aligned on opposite sides of the tubular structure, the pair of front cross member holes positioned to receive a pin removably inserted through the pair of front cross member holes and one of the plurality of front cross member sizing holes when the first end or the second of the front central cross member is received within first end of one of the pair of front outer cross members; whereby a user can select an appropriate set of the front cross member sizing holes to adjust the front cross member to accommodate towed vehicles with different outside widths between the opposing pair of tires to be raised; and
ii. one of the four turning brackets affixed to the second end of each of the pair of front outer cross members;
C. the rear central cross member having a first end and a second end, the first end and the second each having a plurality of rear cross member sizing holes;
D. each of the pair rear outer cross members having a hollow tubular structure sized to receive the first end or the second end of the rear central cross member, and each of the pair of rear outer cross members having a first end and a second end;
i. the first end having a pair of rear cross member holes aligned on opposite sides of the tubular structure, the pair of rear cross member holes positioned to receive a pin removably inserted through the pair of rear cross member holes and one of the plurality of rear cross member sizing holes when the first end or the second of the rear central cross member is received within first end of one of the pair of rear outer cross members; whereby a user can select an appropriate set of the rear cross member sizing holes to adjust the rear cross member to accommodate towed vehicles with different outside widths between the opposing pair of tires to be raised; and
ii. one of the four turning brackets affixed to the second end of each of the pair of rear outer cross members.

11. The dolly of claim 10, wherein a tongue receiver is centrally affixed between the right end and the left end of the front central cross member;
A. the tongue receiver protruding perpendicularly from the length of the front cross central member in a direction to be in physical communication with the rear-lower end of the tongue assembly;
B. the tongue receiver having a tubular structure with a hollow interior, the hollow interior sized and shaped to receive the rear-lower end of the tongue assembly;
C. the tongue assembly including a tongue hole through the rear-lower end of the tongue assembly;
D. the tongue receiver further comprising a pair of tongue receiver holes aligned on opposite sides of the tubular structure, the tongue receiver holes positioned to receive a pin removably inserted through the aligned tongue hole and the pair of tongue receiver holes when the rear-lower end of the tongue assembly is received within the tongue receiver;
E. whereby the tongue assembly is removably affixed to the front central cross member.

12. The towing dolly of claim 11, wherein each of a pair of jacks is affixed to each of the pair of side cross-member pillars and wherein each of the jacks is movable to raise the rectangular frame.

13. The towing dolly of claim 11, wherein the dolly includes an attachment for a motorcycle, the attachment including a motorcycle wheel channel having a length to support a front wheel and rear wheel of a motorcycle, the attachment affixed to the front cross member and rear cross member.

14. A method of pulling a towed vehicle with a towing vehicle using a towing dolly, the method comprising:
A. placing a rear cross member of the towing dolly on a driving surface underneath the towed vehicle so that the rear cross member rests between a pair of front tires and a pair of rear tires on the towed vehicle, the rear cross member having a first end and a second end, and the rear cross member having a length sufficient to span the width of the towed vehicle;
B. placing one of a pair of side cross members of the towing dolly on the driving surface along a length of a contact patch on an outside of one of a pair of opposing tires to be raised on the towed vehicle, each side cross member having a first end and a second end, and each of the pair of side cross members having a length sufficient to span the length of the contact patch, and each side cross member having a vehicle-raising tower, the vehicle raising tower sized and structured to receive an axle tower;
C. placing another one of the pair of side cross members on the driving surface along the length of the contact patch on the outside of an opposite one of the pair of opposing tires to be raised on the towed vehicle;
D. sliding the rear cross member along the driving surface until the rear cross member is adjacent to each of the contact patches on each of the opposing pair of tires to be raised on the towed vehicle;
E. hingeably affixing the first end of the rear cross member to the first end of one of the pair of side cross members to allow limited rotation in a horizontal plane of the rear cross member and one of the pair of side cross members;
F. hingeably affixing the second end of the rear cross member to the second end of the opposite one of the pair of side cross members to allow limited rotation in a horizontal plane of the rear cross member and the opposite one of the pair of side cross members;
G. placing a front cross member of the towing dolly on the driving surface underneath the towed vehicle; the front cross member having a right end and a left end, and the front cross member having a length equal to the rear cross member;
H. sliding the font cross member along the driving surface until the front cross member is adjacent to each of the contact patches on each of the opposing pair of tires to be raised on the towed vehicle, the front cross member positioned opposite the rear cross member across the contact patches of the opposing pair of tires to be raised on the towed vehicle;
I. hingeably affixing the right end of the front cross member to the first end of one of the pair of side cross members to allow limited rotation in a horizontal plane of the front cross member and one of the pair of side cross members;
J. hingeably affixing the left end of the front cross member to the second end of the opposite one of the pair of side cross members to allow limited rotation in a horizontal plane of the front cross member and the opposite one of the pair of side cross members;
K. removably affixing a tongue assembly to the front cross member, the tongue section having a rear-lower end and front-upper end, the rear-lower end removably affixed to a central point on the length of the front cross member, the tongue assembly protruding perpendicularly away from the front cross member toward physical communication with a hitch on the tow vehicle, the front-upper end having a ball socket, the ball socket configured for removable attachment to the hitch;
L. removably attaching the ball socket to the hitch;
M. inserting the axle tower on one of a pair of dolly wheel assemblies into the vehicle-raising tower affixed to one of the pair of side cross members;
N. inserting an opposite one of the pair of axle towers into the vehicle-raising tower affixed to the opposite side cross member;
O. rotating one of a pair of vehicle-raising bolts to draw one of the pair of vehicle raising towers toward an upper plate on one of the pair of axle towers, whereby one of the pair of tires to be raised on the towed vehicle is raised above the driving surface;
P. rotating an opposite one of the pair of vehicle-raising bolts to draw the opposite vehicle raising tower toward the upper plate on the opposite one of the pair of axle towers, whereby the opposite one of the pair of tires to be raised on the towed vehicle is raised above the driving surface; and
Q. towing the towed vehicle with the towing vehicle, using the towing dolly.

15. The method of claim 14, wherein the length of rear cross member is adjustable and the length of the front cross member is adjustable, whereby towed vehicles of varying widths can be accommodated, the method additionally comprising:
A. adjusting the length of the rear cross member to span the width of the towed vehicle;
B. adjusting the length of the front cross member to span the width of the towed vehicle; and
C. ensuring that the adjusted length of the rear cross member is equal to the adjusted length of the front cross member .

16. The method of claim 14, wherein the length of each of the pair of side cross members is adjustable, the method additionally comprising:
A. adjusting the length of one of the pair of side cross members to span the length of the contact patch on one of the pair of tires to be raised on the towed vehicle;
B. adjusting the length of the opposite one of the pair of side cross members to span the length of the contact patch on the opposite one of the pair of tires to be raised on the towed vehicle; and
C. ensuring that the adjusted length of one side cross member is equal to the adjusted length of the opposite side cross member.
